(19) United States
(12) Patent Application Publication
(10) Pub. No.: US 2005/0135269 A1
(43) Pub. Date: Jun. 23, 2005

(54) Automatic configuration of a virtual private network

(76) Inventors: Ylian Saint-Hilaire, Hillsboro, OR (US); Bryan Y. Roe, Camas, WA (US); Nelson F. Kidd, Camas, WA (US)

Correspondence Address: BUCKLEY, MASCHOFF, TALWALKAR LLC, 5 ELM STREET, NEW CANAAN, CT, 06840, US

(21) Appl. No.: 10/743,226

(22) Filed: Dec. 22, 2003

(51) Int. Cl. H04L 12/28

(52) U.S. Cl. 370/254; 370/401

(57) ABSTRACT

A system, an apparatus, and a method for automatically configuring a virtual private network. The system, apparatus, and method include providing virtual private network settings to the node in a common format for automatic exchange of information between networked devices.

### BACKGROUND

Public networks, such as the Internet or a public switched telephone network (PSTN), are typically inherently unsafe because they are open to the public and members of the public may intrude upon or attack a node on the public network. A Virtual Private Network (VPNs) provides a secure tunnel through a public network to a private network. To maintain security, VPNs generally use tunneling protocols to transmit private information through a public network securely. Configuration of a VPN tunnel is generally complex, requiring a combination of custom software download and manual configuration for each node to be utilized on the VPN. That configuration may, moreover, have to be performed each time there is an upgrade to the VPN because VPNs typically operate with predefined data communication paths and user members.

### BRIEF DESCRIPTION OF THE DRAWINGS

The accompanying drawings, wherein like reference numerals are employed to designate like components, are included to provide a further understanding of automatic configuration of a virtual private network, are incorporated in and constitute a part of this specification, and illustrate embodiments of automatic configuration of a virtual private network that together with the description serve to explain the principles of such automatic configuration.

In the drawings:

FIG. 1a illustrates a network in which an embodiment of automatic configuration of a virtual private network may take place;

FIG. 1b illustrates a network in which an embodiment of a virtual private network may operate;

FIG. 2 illustrates an embodiment of a device for automatically configuring a virtual private network; and

FIG. 3 illustrates an embodiment of a method of automatically configuring a virtual private network.

### DETAILED DESCRIPTION

Reference will now be made to embodiments of automatic configuration of a virtual private network, examples of which are illustrated in the accompanying drawings. Details, features, and advantages of automatic configuration of a virtual private network will become further apparent in the following detailed description of embodiments thereof.

Any reference in the specification to “one embodiment,” “a certain embodiment,” or a similar reference to an embodiment is intended to indicate that a particular feature, structure, or characteristic described in connection with the embodiment is included in at least one embodiment of automatic configuration of a virtual private network. The appearances of such terms in various places in the specification are not necessarily all referring to the same embodiment. References to “or” are furthermore intended as inclusive so “or” may indicate one or the other ored terms or more than one ored term.

An entity such as a corporation may operate a closed private network in remote locations by purchasing or leasing lines, such as telephone lines, that may be coupled directly to the corporate network to minimize interference from users or nodes that are not part of the entity. That type of solution, however, is generally expensive in comparison to opening the private network to permit access to the private network from a public network. Therefore, it may be desirable to have a system in which secure communications may occur through a public network.

A virtual private network, or VPN, may be used to couple a node to a private network when that node is coupled to a public network and maintains secure communications on the public network through a tunneling protocol. A tunneling protocol is a procedure that generally encapsulates data and protocol information transmitted on the public network in one or more packets or other transmission units utilized by the public network. The tunneling protocol then may transmit the packet or other transmission unit so that the private network information appears to be data when it passes through the public network. The tunnel thereby transmits private information through the public network in a way that routing nodes in the public network are not made aware that the information is associated with the private network and that makes the information appear to be of little interest or unreadable to users or nodes on the public network that might want to improperly collect and review the information.

VPNs may, for example, be used by corporations to permit employees utilizing portable computers to access resources of a corporate network even when the employee is not in a normal work area and the portable computer is not docked directly to the corporate network. In that way, an employee having a VPN enabled portable computer or other VPN enabled workstation node can disconnect the workstation from the corporation's private network, travel to a remote location in which the corporate network is not available directly, and couple the workstation to a public network, yet still securely access resources of the corporate network from that remote location through the public network.

In another example, a VPN may be used in a home to permit secure communications with a home network through a node coupled to a pubic network. VPNs, however, whether coupled to corporate networks, home networks or other networks, generally require complex individualized configuration of every node to be VPN enabled and may disrupt computer operation if not configured correctly. Thus the use of VPNs may be limited to high level users that have the substantial resources that may be required to manage the VPN.

An automatic exchange of information between devices in a common format may be desirable to provide virtual private network settings to one or more nodes that are to be enabled for the virtual private network. For example, a network discovery protocol such as Universal Plug and Play (UPnP®) may perform the automatic exchange of information between devices. UPnP® is an open industry standard that generally uses Internet protocols and commonly recognized instructions to enable coupled devices to automatically detect and communicate with each other. UPnP® includes a group of standards that are available at http://upnp.org/. Automatic configuration of a VPN may, for example, be accomplished utilizing UPnP® Internet Gateway Device (IGD) services, the standard for which was adopted on Nov. 12, 2001, and is available at http://upnp.org/. UPnP® may operate using peer-to-peer network conductivity over which devices may automatically communicate control information and data and node specific information. Another protocol for automatic exchange of information between networked devices may alternately be used to provide VPN settings to nodes that are desired to be VPN enabled.

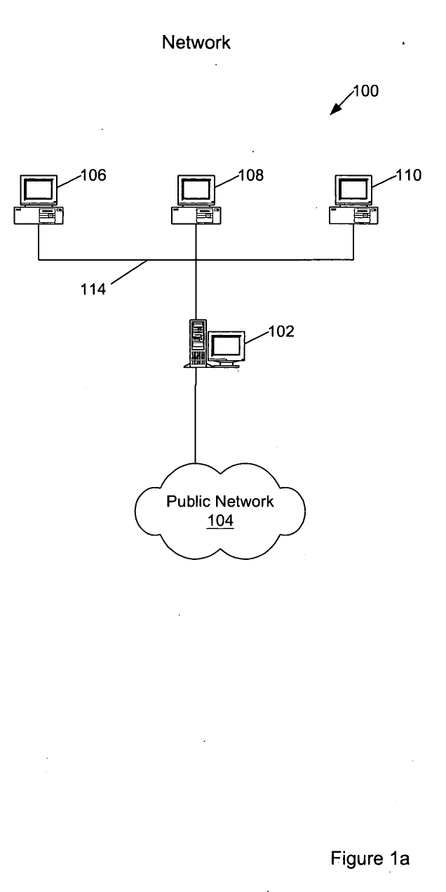

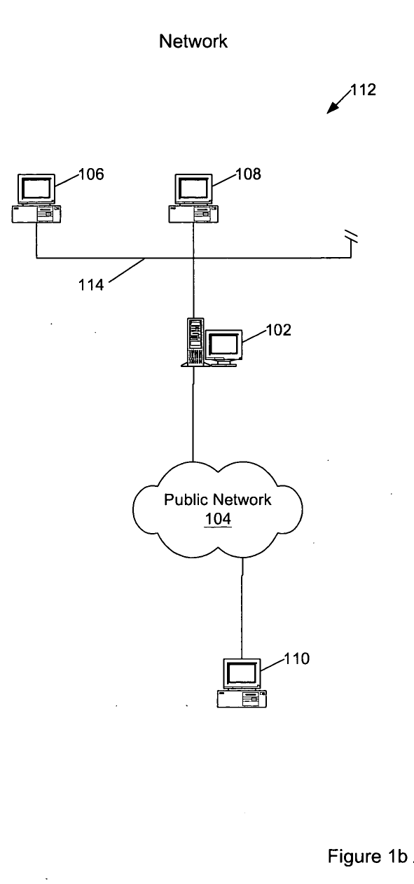

FIG. 1a illustrates an embodiment of a network 100 in which automatic configuration of a VPN may operate. The network 100 includes a gateway 102 coupled to a public network 104, and a first workstation 106, a second workstation 108, and a third workstation 1 10 coupled to the gateway 102 by way of a private network 114. The gateway 102 may be any node, including a VPN server, in which VPN settings may be established or through which remotely coupled nodes may communicate with a private network through a VPN tunnel. The workstations 106-110 may alternately communicate with the private network 114 through the public network 104 by way of the gateway 102, which may also act as a firewall to prevent undesired information from entering the private network 114. Thus, a VPN may be configured at the gateway 102 and the workstations 106-110 may be configured for VPN operation automatically by providing virtual private network settings to the workstations 106-110 in a common format for automatic exchange of information between networked devices, such as UPnP®.

FIG. 1b illustrates an embodiment of a network 112 that is a reconfiguration of the network 100 illustrated in FIG. 1a and in which a node such as the workstation 110 configured for VPN operation may be used. The network 112 of FIG. 1b, like the network 100 of FIG. 1a, includes the gateway 102 coupled to the public network 104 and the private network 114, the first workstation 106, the second workstation 108, and the third workstation 110. The third workstation 110, however, is not coupled to the gateway 102 by way of the private network 114 in the network 112 of FIG. 1b. Rather the third workstation 110 is coupled to the public network to communicate with the gateway 102 by way of a VPN.

Thus, the third workstation 110 may have been enabled for VPN operation while coupled to the gateway 102 on the private network 114 as illustrated in FIG. 1a, then disconnected from the private network 114 and moved to the remote location with access to the public network 104. The third workstation 110 may then have been coupled to the public network 102 and communicate with the gateway 102 and the first workstation 106 and second workstation 108 therethrough.

The network in which automatic configuration of a virtual private network is implemented may be a private network such as a Local Area Network (LAN) or Wide Area Network (WAN). After automatic configuration of a virtual private network is enabled in a node, such as a portable computer workstation, coupled to the private network, the node may be coupled to the private network by way of the VPN through a public network such as the Internet or a Public Switched Telephone Network (PSTN).

Where access to a VPN is desired through a PSTN, many phone numbers, possibly in local networks throughout the world, may be made available to VPN users for coupling to the proximity network. Those phone numbers may, furthermore, change from time to time or on a regular basis, necessitating that the VPN be updated to reflect each change. Thus, where regularly changing phone numbers are used for coupling to a VPN, updates to VPN settings on every node enabled for VPN operation may be required regularly, further benefiting the VPN from use of automatic configuration.

Those nodes that may operate on a VPN range from portable personal computers to high-end mainframe computers and supercomputers and other, typically processor-based, devices interconnected by one or more forms of communication media. Those nodes may furthermore act, for example, as routers, switches, servers, workstations, and clients. The communication media coupling those devices may include, for example, twisted pair, co-axial cable, optical fibers and wireless communication methods such as use of radio frequencies.

Nodes may operate as source nodes, destination nodes, intermediate nodes or a combination of those source nodes, destination nodes, and intermediate nodes. Information may furthermore be passed from source nodes to destination nodes over a private or public network, often through one or more intermediate nodes. For example, the gateway 102 of FIGS. 1a and 1b may operate as an intermediate node when it is used to couple remote workstations 106-110 coupled to a public network to nodes on the private network 114. The workstation nodes may operate as source nodes when passing information to other workstations 106-110 or to nodes on the public network 104. The workstation nodes may also operate as destination nodes when receiving information from other workstations 106-110 or nodes on the public network 104. The gateway 102 may also act as a destination node when receiving a request from a workstation 106-110 for VPN settings and as a source node when transmitting those VPN settings to a workstation 106-110.

Information may comprise any data capable of being represented as a signal, such as an electrical signal, optical signal, acoustical signal and so forth. Examples of information in this context may include one or more packets of data being sent from a source node to a destination node. Those packets may include, for example, VPN settings or information being passed through a VPN tunnel.

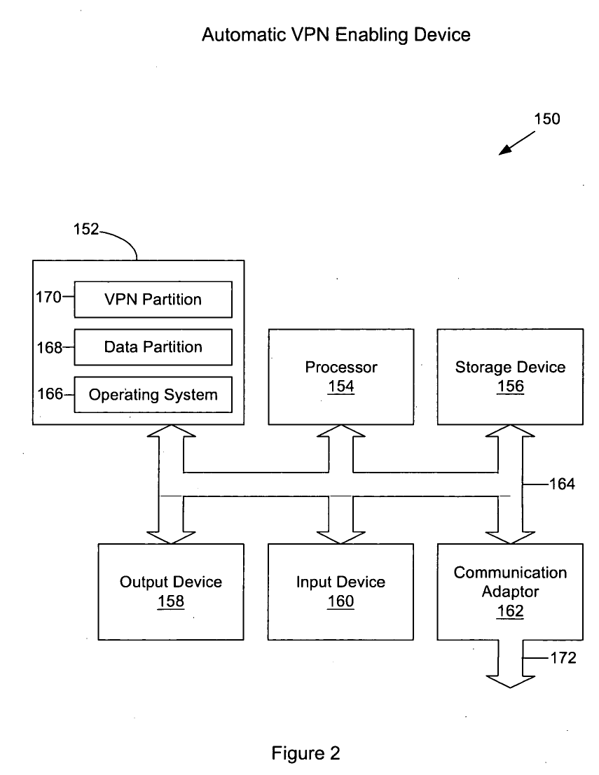

FIG. 2 illustrates an automatic virtual private network enabling device 150 that may operate as a variety of nodes including a VPN gateway 102 and a workstation 106-110. Such an automatic virtual private network enabling device 150 may automatically receive VPN settings from a VPN gateway 102 when a VPN is first enabled and may receive updated VPN settings when the VPN is modified when acting as a workstation 106-110. If desired, such an automatic virtual private network enabling device 150 acting as a workstation 106-110 may receive a notification from the gateway when VPN settings are available from the gateway 102 and a user of the workstation 106-110 may manually enable the automatic downloading of the VPN settings from the gateway 102 to the workstation 106-110.

Such an automatic virtual private network enabling device 150 may automatically transmit VPN settings when a VPN is first enabled and when the VPN is modified when acting as a gateway 102. If desired, such an automatic virtual private network enabling device 150 acting as a gateway 102 may transmit a notification from the gateway 102 when VPN settings are available from the gateway so that a user of the workstation 106-110 may manually enable the automatic downloading of the VPN settings from the gateway 102 to the workstation 106-110. Those settings may furthermore be node specific, having varying settings for different nodes. Such an automatic virtual private network enabling device 150 operating as a VPN gateway 102 may furthermore operate to make devices coupled to the private network aware that a VPN tunnel service is available to devices coupled to the private network by way of a public network.

The automatic virtual private network enabling device 150 includes memory 152, a processor 154, a storage device 156, an output device 158, an input device 160, and a communication adaptor 162. It should be recognized that any or all of the components 152-162 of the automatic virtual private network enabling device 150 may be implemented in a single machine. For example, the memory 152 and processor 154 might be combined in a state machine or other hardware based logic machine. Communication between the processor 154, the storage device 156, the output device 158, the input device 160, and the communication adaptor 162 may be accomplished by way of one or more communication busses 164.

The memory 152 may, for example, include random access memory (RAM), dynamic RAM, and/or read only memory (ROM) (e.g., programmable ROM, erasable programmable ROM, or electronically erasable programmable ROM) and may store computer program instructions and information. The memory 152 may furthermore be partitioned into sections including an operating system partition 166, wherein instructions may be stored, a data partition 168 in which data may be stored, and a VPN partition 170 in which instructions related to operation of a virtual private network may, for example, be stored in the gateway 102 and instructions for operation of a node on such a virtual private network may, for example, be stored in the workstations 106-110. The VPN partition 170 may also allow execution by the processor 154 of the instructions stored in the VPN partition 170. The data partition 168 may furthermore store data to be used during the execution of the program instructions such as, for example, settings for the VPN and information identifying nodes authorized to operate on the VPN.

The processor 154 may execute the program instructions and process the data stored in the memory 152. In one embodiment, the instructions are stored in memory 152 in a compressed and/or encrypted format. As used herein the phrase, “executed by a processor” is intended to encompass instructions stored in a compressed and/or encrypted format, as well as instructions that may be compiled or installed by an installer before being executed by the processor 154.

The storage device 156 may, for example, be a magnetic disk (e.g., floppy disk or hard drive), optical disk (e.g., CD-ROM) or any other device or signal that can store digital information. The communication adaptor 162 may permit communication between the automatic virtual private network enabling device 150 and other devices or nodes coupled to the communication adaptor 162 at a communication adaptor port 172. The communication adaptor 162 may be a network interface that transfers information from nodes on a network such as the network 100 illustrated in FIG. 1, to the automatic virtual private network enabling device 150 or from the automatic virtual private network enabling device 150 to nodes on the network 100. It should be noted that the automatic virtual private network enabling device 150 may alternately be coupled to a variety of networks as described hereinabove. It will also be recognized that the automatic virtual private network enabling device 150 may alternately or in addition be coupled directly to one or more other devices through one or more input/output adaptors (not shown).

The automatic virtual private network enabling device 150 may also be coupled to one or more output devices 158 such as, for example, a monitor or printer, and one or more input devices 160 such as, for example, a keyboard or mouse. It will be recognized, however, that the automatic virtual private network enabling device 150 does not necessarily need to have any or all of those output devices 158 or input devices 160 to operate. It should also be recognized that the automatic virtual private network enabling device 150 may have fewer components or more components than shown in FIG. 2.

The elements 152, 154, 156, 158, 160, and 162 of the automatic virtual private network enabling device 150 may communicate by way of one or more communication busses 164. Those busses 164 may include, for example, a system bus, a peripheral component interface bus, and an industry standard architecture bus.

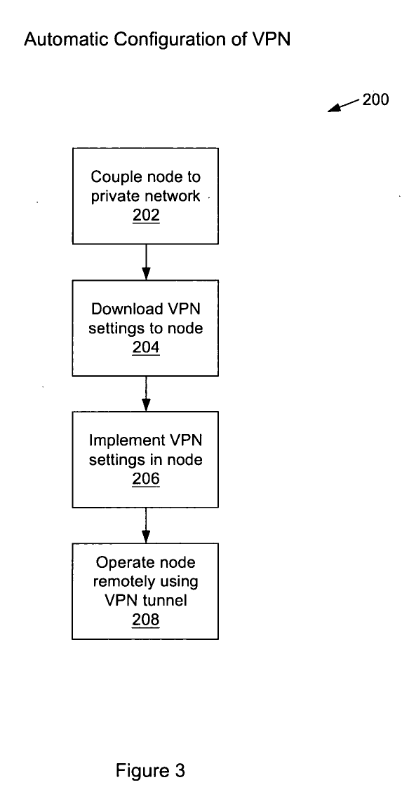

FIG. 3 illustrates an embodiment of a method of automatically configuring and enabling a virtual private network 200 to enable a node to communicate by way of a VPN tunnel. At 202, a workstation is coupled to a private network similarly to the way that the third workstation 110 is coupled to the network 100 illustrated in FIG. 1a. By coupling the workstation to a private network, secure communications may be transmitted between nodes with little opportunity for interception or modification by an unauthorized user.

At 204, the workstation downloads VPN settings from the VPN gateway or another server that is acting as a repository for VPN settings. During such a download, a gateway or other central VPN device may provide virtual private network settings to the node in a common format for automatic exchange of information between networked devices. The common format for automatic exchange of information between networked devices may, for example, include Universal Plug and Play and may further involve HTML and XML formatting of information.

UPnP® is currently an Extensible Markup Language (XML) based protocol that is implemented on Hypertext Transfer Protocol (HTTP). XML provides a flexible way to create common information formats and share both the format and the data on a public or private network. As such, any user of a public network, for example, may collect XML formatted data from various nodes on the network and compare that data in a consistent way. XML version 1.0 is a second edition of XML that was recommended on Oct. 6, 2000 and is available from www.w3.org. HTTP is an application level protocol that includes a set of rules for transferring files of information, such as text, graphic images, sound, and video, on the World Wide Web. HTTP version 1.1 is available at ftp.isi.edu, and is identified as request for comment 2616.

When a first UPnP® enabled device is coupled to other UPnP® enabled devices in, for example, a node or network, the device may configure itself, acquire a TCP/IP address, and transmit its presence in a message to other coupled devices by way of a common protocol such as, for example, HTTP.

A request may also be made using universal plug and play. Such a request might be made over a network by a device such as a workstation node 106-110. The workstation node 106-110 may, for example, transmit a request to determine whether a VPN tunnel is available for that workstation node 106-110 using universal plug and play. Such a request may, for example, be-formatted in a common protocol such as HTTP using, for example, XML and a VPN server, such as the gateway 102 may respond by transmitting its Universal Resource Locator (URL) and a commonly formatted description of the services the gateway 102 can provide to the workstation node 106-110. Settings may then be transmitted between the workstation node 106-110 and gateway 102 so that the workstation node 106-110 may be configured and enabled for VPN operation automatically without user input or with any desired level of user input.

A download of VPN information may be initiated automatically by either the workstation 106-110 or a VPN repository node, such as the gateway 102, or may be initiated manually by a user of either the workstation 106-110 or the gateway 102. In an embodiment, the gateway 102 transmits a message to all nodes 106-110 that are authorized to operate using the VPN on the private network 114 that VPN settings are available for downloading. Those settings may be to enable a new VPN or to update an existing VPN. Those nodes 106-110 receiving the message from the gateway 102 may then download those settings from the gateway 102 when convenient either because, for example, the node 106-110 is not busy or the user of the node 106-110 responds to the message requesting download of the VPN settings. The gateway 102 may furthermore confirm that each requesting node 106-110 is authorized to operate on the VPN before transmitting the VPN settings to each node 106-110.

In an embodiment, each workstation 106-110 will have a presentation page that appears on the workstation 106-110 automatically when communication with the VPN gateway 102 is established and VPN settings are available for downloading to the workstation 106-110 from the VPN gateway 102. That presentation page may include instructions for downloading the settings and a download pointer to software on the gateway 102 to be downloaded to enable or update VPN settings. A user may select the download pointer to automatically download and enable the VPN settings. Once the VPN software is downloaded to a workstation 106-110 or other node, the VPN software may find a VPN UPnP® main device, such as the VPN gateway 102, automatically and configure itself for operation or updated operation on the VPN. Moreover, because updates to VPN settings may include a large amount of information that is unchanged, the VPN software for an update may include a revision number or indicator of portions of the settings that have been updated. Nodes 106-110 that communicate with the VPN gateway 102 may then compare the revision number against the most recent revision downloaded by that node to determine whether a download is necessary or may download only the settings that have been modified to minimize network traffic and time required to perform the download. Specialized settings that may be applicable to only one or a portion of the nodes 106-110 receiving VPN settings may also be communicated using UPnP®.

At 206, the enabled workstation node 106-110 may implement the VPN settings so that it may operate with the private network 114 through a VPN tunnel. At 208, once the workstation has been configured for VPN operation and thus enabled to operate on the subject VPN, the workstation 106-110 may be uncoupled from the private network 114 and indirectly re-coupled to that network 114 remotely by way of a VPN tunnel operating on a public network 104 as illustrated by the third workstation 110 in FIG. 1b. The workstation 110 may then again operate as a node on the private network 114 securely over the public network 104 because the VPN limits access to unauthorized users coupled to the public network 104.

VPN related information and settings utilized to enable a VPN tunnel may include, for example, an address of the private network on the public network 104, a port identifier for the private network on the public network 104, an encryption system supported by the VPN with which information communicated between nodes on the VPN may be encrypted, and an authentication system supported by the VPN with which nodes attempting to communicate by way of the VPN will be authenticated and communications from nodes that are not authenticated may be rejected.

The VPN settings at every node included in the VPN may have to be modified every time a change is made to the VPN. For example, if a new node is added to the VPN, every node in the VPN will typically have to have its VPN settings updated to communicate with the new node. As changes to the VPN may be common and modifications to the VPN may be complex, it may be unreasonably difficult to maintain a VPN when changes must be implemented in every node. Automatic configuration and enabling of all nodes operating on a VPN by making changes to a single node, such as the gateway 102 and having those changes automatically transmitted to and enabled in all other nodes, by way, for example, of UPnP® may significantly simplify VPN updating making VPNs more viable for home networks and business networks.

When a VPN is operating over a small network, such as a home network that may be similar to the network 100 shown in FIG. 1a, changes in VPN settings may be implemented in the gateway 102 and automatically downloaded to the workstations 106-110 and enabled in the workstations 106-110 when workstations 106-110 are next powered-on. When a VPN is operating over a larger network, such as a business network having potentially many more nodes than illustrated in the network 100 illustrated in FIG. 1a, it may be desirable to provide a message to each node operating in the network that the VPN has been updated. The user of each node may then respond to the message by, for example, selecting an “OK” button on their screen with a mouse click when they want the new VPN settings to be downloaded and enabled, thus creating a new “corporate remote connection” in each node to be included on the VPN. The user of the node requesting the VPN information may furthermore be authenticated by the gateway 102 by asking for user information before the VPN information is downloaded to the requesting node.

A selected subgroup of nodes in a business or home network may, furthermore, be included on the VPN, while other nodes in the business or home network may not be VPN enabled. For example, portable computers, such as notebook computers, in the network may be automatically VPN enabled, while non-portable computers, such as desktop computers and tower type computers may not be VPN enabled because they are not typically moved to remote locations. That may be so because a typical purpose for a VPN is to allow for remote access by network nodes and so only nodes that are intended to have their direct coupling to be network be uncoupled and then be re-coupled remotely by way of a public network may need to be VPN enabled.

The address of the private network on the public network 104 may be, for example, an Internet Protocol (IP) address where the public network 104 is, for example, the Internet. Network nodes may be equipped with the appropriate hardware, software or firmware necessary to communicate information in accordance with one or more protocols. A protocol may comprise a set of instructions by which the information is communicated over a communication medium. Protocols are, furthermore, often layered over one another to form something called a “protocol stack.” In an embodiment, the network nodes that are communicating on the VPN operate in accordance with an IP network protocol layer.

Various versions of IP may be utilized in connection with the automatic virtual private network enabling device 150, including IP version 4 (IPv4) and IP version 6 (IPv6). IPv4 is defined by Internet Engineering Task Force (IETF) standard 5, Request for Comment (RFC) 791 and was adopted in September, 1981, while IPv6 is defined by IETF RFC 2460 and was published in December, 1998. Both IP standards are available from www.ietf.org.

Automatic configuration of a virtual private network may also be implemented in an article of manufacture that includes a computer readable medium having stored thereon instructions which, when executed by a processor, cause the processor to automatically enable VPN operation on a node, whether that node is directly coupled to the private network (through wire, fiber optic cable, or radio frequency, for example) or that node is not directly coupled to the private network. Thus, by utilizing the article of manufacture, a node, such as a server or non-portable workstation that is not coupled to the private network may be enabled to couple to the network through a public network by way of the VPN.

In addition to automatically downloading VPN settings to VPN nodes, automatic enabling of VPN nodes may create or assist in authentication of nodes and users by, for example, utilizing UPnP® security functions. Automatic enabling of VPN nodes may also issue a request to have VPN service enabled at a node by, for example, contacting the gateway 102 and requesting VPN privileges by way of UPnP®. Such a request may be authenticated automatically to assure it was received from an authorized node or user and a determination as to whether a requesting node requires new account creation or a lesser upgrade may be made automatically using UPnP®.

While the systems, apparatuses, and methods of automatic configuration of a VPN have been described in detail and with reference to specific embodiments thereof, it will be apparent to one skilled in the art that various changes and modifications can be made therein without departing from the spirit and scope thereof. Thus, it is intended that the modifications and variations be covered provided they come within the scope of the appended claims and their equivalents.

1. A method of configuring a node for virtual private network operation, comprising providing virtual private network settings to the node in a common format for automatic exchange of information between networked devices.

2. The method of claim 1, wherein the common format for automatic exchange of information between networked devices is universal plug and play.

3. The method of claim 1, wherein providing includes transmitting the settings to the node over a private network.

4. The method of claim 3, further comprising transmitting a message from a virtual private network repository node coupled to the private network to the node informing the node that virtual private network settings are available for downloading from the virtual private network repository node.

5. The method of claim 4, further comprising requesting download of the virtual private network settings to the node.

6. The method of claim 5, further comprising confirming that the requesting node is authorized to operate on the virtual private network.

7. A virtual private network gateway, comprising:
a communication adaptor coupled to a network; and
a processor coupled to the communication adaptor to transmit virtual private network settings to another node coupled to the network in a common format for automatic exchange of information between networked devices.

8. The virtual private network gateway of claim 7, wherein the network is a private network.

9. The virtual private network gateway of claim 7, wherein the network is a local area network.

10. The virtual private network gateway of claim 7, wherein the network is a wide area network.

11. The virtual private network gateway of claim 7, wherein the common format for automatic exchange of information between networked devices includes universal plug and play.

12. The virtual private network gateway of claim 7, wherein the processor is further to transmit a message to the other node informing the other node that virtual private network information is available from the virtual private network gateway.

13. The virtual private network gateway of claim 7, wherein the processor is further to confirm that the other node is authorized to operate on the virtual private network.

14. A virtual private network gateway, comprising:
a communication adaptor coupled to a network;
a processor coupled to the communication adaptor to provide virtual private network settings to another node coupled to the network in a common format for automatic exchange of information between networked devices; and
a storage device coupled to the processor to contain the virtual private network settings.

15. The virtual private network gateway of claim 14, wherein the processor is to retrieved the virtual private network settings from the storage device and transmit the virtual private network settings to the other node automatically utilizing universal plug and play.

16. A virtual private network node, comprising:
a communication adaptor coupled to a network; and
a processor coupled to the communication adaptor to receive virtual private network settings from another node coupled to the network in a common format for automatic exchange of information between networked devices.

17. The virtual private network gateway of claim 16, wherein the network is a local area network.

18. The virtual private network gateway of claim 16, wherein the network is a wide area network.

19. The virtual private network gateway of claim 16, wherein the common format for automatic exchange of information between networked devices includes universal plug and play.

20. The virtual private network gateway of claim 16, wherein the processor is further to transmit a message to the other node requesting that virtual private network information be downloaded.

21. An article of manufacture, comprising:
a computer readable medium having stored thereon instructions which, when executed by a processor, cause the processor to provide virtual private network settings to a remote node in a common format for automatic exchange of information between networked devices.

22. The article of manufacture of claim 21, wherein the common format for automatic exchange of information between networked devices is universal plug and play.

23. The article of manufacture of claim 21, wherein the settings are transmitted to the node over a private network.

24. An article of manufacture, comprising:
a computer readable medium having stored thereon instructions which, when executed by a processor, cause the processor to retrieve virtual private network settings from a remote node in a common format for automatic exchange of information between networked devices.

25. The article of manufacture of claim 24, wherein the common format for automatic exchange of information between networked devices is universal plug and play.

26. The article of manufacture of claim 24, wherein the settings are transmitted to the node over a private network.
